(19) United States
(12) Patent Application Publication
(10) Pub. No.: US 2025/0075907 A1
(43) Pub. Date: Mar. 6, 2025

(54) BODIES CONFIGURED FOR USE IN RADIANT TUBES

(71) Applicant: SAINT-GOBAIN CERAMICS & PLASTICS, INC., Worcester, MA (US)

(72) Inventors: Bradley NAKANISHI, Natick, MA (US); Catherine Goulas, Aubervilliers (FR); Pierre Gougeon, Paris (FR); Thomas D. Briselden, North Hero, VT (US)

(21) Appl. No.: 18/821,428

(22) Filed: Aug. 30, 2024

Related U.S. Application Data
(60) Provisional application No. 63/579,981, filed on Sep. 1, 2023.

(51) Int. Cl. F23D 14/62; B01F 25/4314; B01F 101/00; F23D 14/12

(52) U.S. Cl. CPC F23D 14/62; B01F 25/43141; F23D 14/12; B01F 2101/501; F23D 2203/002

(57) ABSTRACT

A system to be installed into a radiant tube for reduction of pollutants, the system having a body having a tube shape including a length L_{B}, an outer diameter OD_{B}, and an inner diameter ID_{B}, wherein the body further comprises a proximal surface, a terminal surface, and a circumferential surface extending between the proximal surface and terminal surface, and at least two helical bodies each having a substantially helical shape including a length L_{H}, and an outer diameter OD_{H}, wherein an axial distance (E) between the at least two helical bodies is at least 1% of the length L_{H}.

### CROSS-REFERENCE TO RELATED APPLICATION(S)

This application claims priority under 35 U.S.C. § 119 (c) to U.S. Provisional Application No. 63/579,981, entitled “BODIES CONFIGURED FOR USE IN RADIANT TUBES,” by Bradley NAKANISHI et al., filed Sep. 1, 2023, which is assigned to the current assignee hereof and incorporated herein by reference in its entirety.

### FIELD OF THE DISCLOSURE

The present disclosure relates to bodies for use in or with radiant tubes.

### BACKGROUND

Combustion of fossil fuels introduces emissions into the atmosphere, such as nitrogen oxides (NOx). NOx emissions arise from nitrogen present in the combustion air and from fuel-bound nitrogen in coal or fuel oil, for example. Conversion of fuel-bound nitrogen to NOx depends on the amount and reactivity of the nitrogen compounds in the fuel and the amount of oxygen in the combustion area. Conversion of atmospheric nitrogen, N₂, present in the combustion air to NOx is temperature-dependent; the greater the flame temperature in the combustion area, the greater the resultant NOx content in the emissions. Growing environmental concern is leading to even more stringent regulation of NOx emissions.

There exists a need to improve furnace systems to reduce pollutants and improve the efficiency of heat exchange.

### BRIEF DESCRIPTION OF THE DRAWINGS

The present disclosure may be better understood, and its numerous features and advantages made apparent to those skilled in the art by referencing the accompanying drawings.

FIG. 1 includes an illustration of a system including a body and at least one helical body according to one embodiment.

FIGS. 2A-2B include illustrations of a body according to an embodiment.

FIGS. 3A-3B include illustrations of a helical body according to an embodiment.

FIG. 4 includes an illustration of a body and a helical body according to an embodiment.

FIG. 5 includes a plot of radiant tube surface temperature vs. distance from start of radiant tube Samples CS1, S2, S3, S4, and S5.

### DETAILED DESCRIPTION

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

As used herein, and unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

The present disclosure is directed to components that may be used in furnaces, such as radiant tubes and/or heat exchangers. The components herein can be adapted for use in any size or shape of radiant tubes, such as U or W tubes, including for example for steel annealing, coating, or heat treating furnaces.

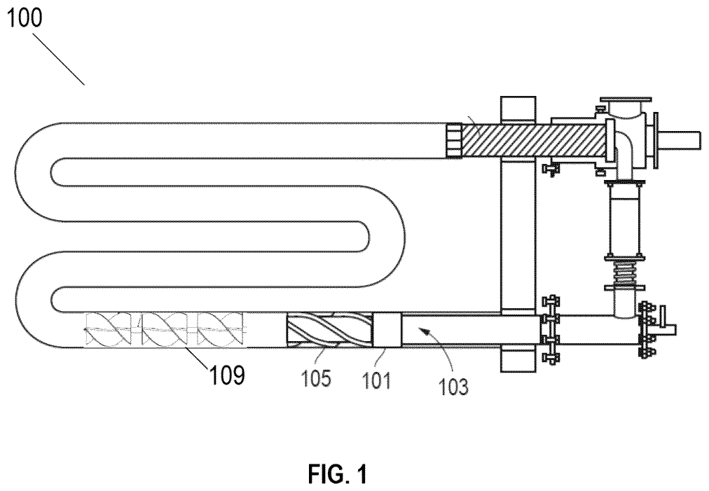

A non-limiting embodiment of a system is provided in FIG. 1. FIG. 1 includes a system 100 including a radiant tube 101 and a burner 103 at least partially disposed in the radiant tube. In one embodiment, the system 100 can include a body 105 and at least one helical body 109 disposed in the radiant tube and configured to reduce the content of pollutants.

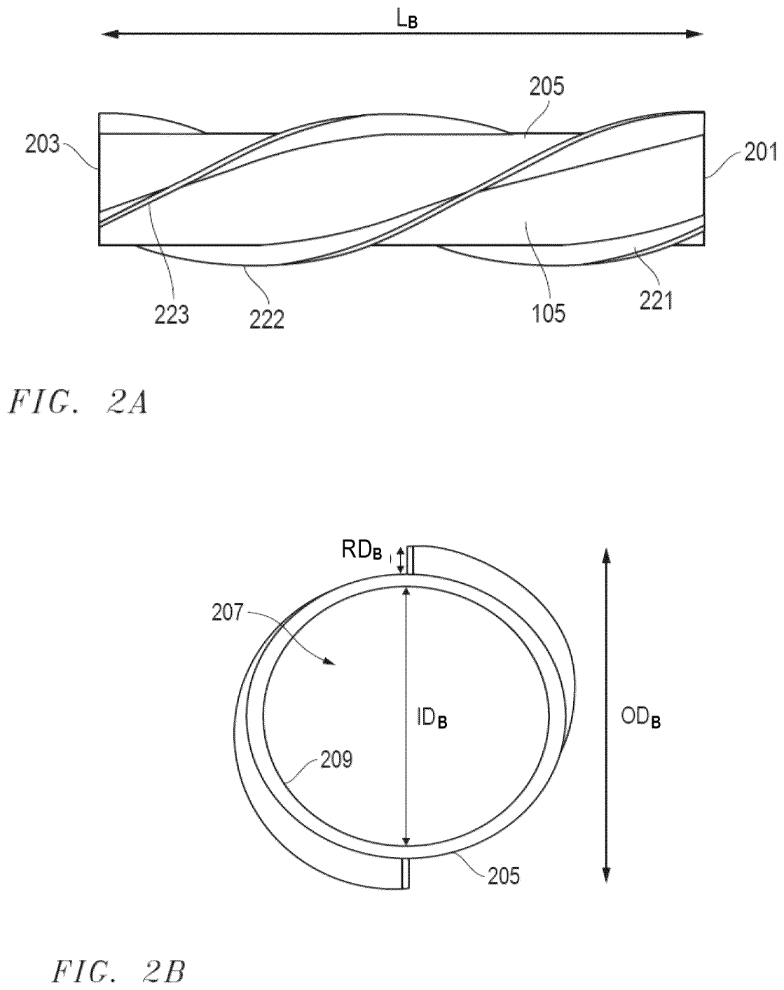

FIG. 2A includes a side-view illustration of a body 105 configured to be disposed in the radiant tube proximate to the burner 103 and configured to reduce the content of pollutants formed during combustion. FIG. 2B includes a cross-sectional illustration of the body 105 according to an embodiment.

In one embodiment, the body 105 may have a generally tubular shape. The body 105 may have a length (L_{B}), an outer diameter (OD_{B}), and an inner diameter (ID_{B}). The outer diameter can be defined by the largest diameter value, which may include the extension of radial members from the body 105. The inner diameter can be defined by the smallest dimension within the central axial opening 207, which can be defined by an inner annular surface 209. The inner diameter can be the smallest dimension between any optional radial members within the central axial opening 207. In one embodiment, the body 105 can include a proximal surface 201, a terminal surface 203, and a circumferential surface 205 extending between the proximal surface 201 and terminal surface 203. In another embodiment, the body 105 can include a central axial opening that may extend for a full length (L_{B}) of the body 105.

In an embodiment, the body 105 may include a length, L_{B}, that may facilitate improved performance of the system 100. For example, in one non-limiting embodiment, the body 105 may include a length, L_{B}, of at least 100 mm, or at least 200 mm, or at least 300 mm, or at least 350 mm, or at least 400 mm, or at least 450 mm, or at least 500 mm, or at least 600 mm, or at least 650 mm, at least 700 mm, at least 750 mm, or at least 800 mm, or at least 850 mm, or at least 900 mm. In still another non-limiting embodiment, the body 105 may include a length, L_{B}, not greater than 1200 mm, or not greater than 1150 mm, or not greater than 1100 mm, or not greater than 1000 mm, or not greater than 950 mm. The length, L_{B}, of the body 105 may be a value between any of the minimum and maximum values noted above, including for example, but not limited to within a range between 100 mm and not greater than 1200 mm, or within a range between 200 mm in not greater than 1000 mm, or within a range between 300 mm in not greater than 950 mm.

In an embodiment, the body 105 may include an outer diameter of the body, OD_{B}, that may facilitate improved performance of the system 100. For example, in one non-limiting embodiment, the body 105 may include an outer diameter of the body, OD_{B}, of at least 70 mm, or at least 80 mm, or at least 90 mm, or at least 100 mm, or at least 110 mm, or at least 120 mm, or at least 130 mm, or at least 140 mm, or at least 150 mm. In still another non-limiting embodiment, the body 105 may include an outer diameter of the body, OD_{B}, not greater than 300 mm, or not greater than 275 mm, or not greater than 250 mm, or not greater than 225 mm, or not greater than 200 mm, or not greater than 190 mm, or not greater than 180 mm, or not greater than 170 mm, or not greater than 160 mm. The outer diameter of the body, OD_{B}, may be a value between any of the minimum and maximum values noted above, including for example, but not limited to within a range between 70 mm and not greater than 300 mm, or within a range between 80 mm in not greater than 275 mm, or within a range between 100 mm in not greater than 250 mm.

In an embodiment, the body 105 may include an outer diameter of the body, OD_{B}, relative to the length of the body L_{B} that may facilitate improved performance of the system 100. For example, in one non-limiting embodiment, the body 105 may include an outer diameter of the body, OD_{B}, of at least 0.01 L_{B}, or at least 0.05 L_{B}, or at least 0.1 L_{B}, or at least 0.15 L_{B}. In still another non-limiting embodiment, the body 105 may include an outer diameter of the body, OD_{B}, not greater than 1 L_{B}, or not greater than 0.9 L_{B}, or not greater than 0.8 L_{B}, or not greater than 0.7 L_{B}, or not greater than 0.6 L_{B}, or not greater than 0.5 L_{B}, or not greater than 0.4 L_{B}, or not greater than 0.3 L_{B}, or not greater than 0.2 L_{B}. The outer diameter of the body, OD_{B}, may be a value between any of the minimum and maximum values noted above, including for example, but not limited to within a range between 0.01 L_{B} and not greater than 1 L_{B}, or within a range between 0.05 L_{B} in not greater than 0.7 L_{B} or within a range between 0.1 L_{B} in not greater than 0.9 L_{B}.

In an embodiment, the body 105 may include an inner diameter of the body, ID_{B}, that may facilitate improved performance of the system 100. For example, in one non-limiting embodiment, the body 105 may include an inner diameter of the body, ID_{B}, of at least 10 mm, or at least 20 mm, or at least 30 mm, or at least 40 mm, or at least 45 mm, or at least 50 mm, or at least 45 mm or at least 60 mm. In still another non-limiting embodiment, the body 105 may include an inner diameter of the body, ID_{B} not greater than 90 mm, or not greater than 85 mm, or not greater than 80 mm, or not greater than 75 mm, or not greater than 70 mm. The inner diameter of the body, ID_{B}, may be a value between any of the minimum and maximum values noted above, including for example, but not limited to within a range between 10 mm and not greater than 90 mm, or within a range between 20 mm in not greater than 80 mm, or within a range between 30 mm in not greater than 70 mm.

In an embodiment, the body 105 may include an inner diameter of the body, ID_{B}, relative to the length of the body L_{B} that may facilitate improved performance of the system 100. For example, in one non-limiting embodiment, the body 105 may include an inner diameter of the body, ID_{B}, of at least 0.01 L_{B}, or at least 0.02 L_{B}, or at least 0.03 L_{B}, or at least 0.04 L_{B}, or at least 0.05 L_{B}, or at least 0.06 L_{B}, or at least 0.07 L_{B}. In still another non-limiting embodiment, the body 105 may include an inner diameter of the body, ID_{B}, not greater than 0.5 L_{B}, or not greater than 0.45 L_{B}, or not greater than 0.4 L_{B}, or not greater than 0.35 L_{B}, or not greater than 0.3 L_{B}, or not greater than 0.25 L_{B}, or not greater than 0.2 L_{B}, or not greater than 0.15 L_{B}, or not greater than 0.1 L_{B}. The inner diameter of the body, ID_{B}, may be a value between any of the minimum and maximum values noted above, including for example, but not limited to within a range between 0.01 L_{B} and not greater than 0.5 L_{B}, or within a range between 0.02 L_{B} in not greater than 0.4 L_{B} or within a range between 0.03 L_{B} in not greater than 0.3 L_{B}.

According to one embodiment, the body 105 can be a monolithic body. In one particular embodiment, the body 105 can have a solid side wall surrounding the central axial opening. Such a configuration may be suitable to define and distinguish two discrete flow streams between the central axial opening 207 and a flowpath along the outside of the tube shape along the outer circumferential surface 205.

In another non-limiting embodiment, the wall thickness (TB) of the body 105 may include a particular thickness that facilitates improved performance of the system. The wall thickness can be defined as the difference between the outer diameter and inner diameter of the body 105, such as wall thickness (T_{B})=OD_{B}−ID_{B}. According to one embodiment, the wall thickness (T_{B}) may be at least 0.1 mm, such as at least 0.2 mm, or at least 0.3 mm, or at least 0.4 mm, or at least 0.5 mm, or at least 0.6 mm, or at least 0.7 mm, or at least 0.8 mm, or at least 0.9 mm, or at least 1 mm, or at least 1.1 mm or at least 1.2 mm, or at least 1.3 mm, or at least 1.4 mm, or at least 1.5 mm, or at least 1.6 mm, or at least 1.7 mm, or at least 1.8 mm, or at least 1.9 mm, or at least 2 mm. In still another non-limiting embodiment, the wall thickness (T_{B}) may be not greater than 6 mm, such as not greater than 5 mm, or not greater than 4 mm, or not greater than 3 mm, or not greater than 2.5 mm. In another embodiment, it will be understood that the wall thickness (T_{B}) may be a value between any of the minimum and maximum values noted above, including for example, but not limited to within a range between 0.1 mm and not greater than 6 mm, or between 0.2 mm and 5 mm, or between 0.3 mm and 1.5 mm.

In an embodiment, the body 105 may include a wall thickness, T_{B}, relative to the inner diameter of the body ID_{B} that may facilitate improved performance of the system 100. For example, in one non-limiting embodiment, the body 105 may include a wall thickness, T_{B}, of at least at least 0.01 ID_{B}, or at least 0.015 ID_{B}, or at least 0.02 ID_{B}, or at least 0.025 ID_{B}. In still another non-limiting embodiment, the body 105 may include a wall thickness, T_{B}, not greater than 0.2 ID_{B}, or not greater than 0.15 ID_{B}, or not greater than 0.1 ID_{B}, or not greater than 0.09 ID_{B}, or not greater than 0.085 ID_{B}, or not greater than 0.08 ID_{B}. The wall thickness, T_{B}, of the body may be a value between any of the minimum and maximum values noted above, including for example, but not limited to within a range between 0.01 ID_{B}, and not greater than 0.2 ID_{B}, or within a range between 0.02 ID_{B}, and not greater than 0.1 ID_{B} or within a range between 0.02 ID_{B}, and not greater than 0.15 ID_{B}.

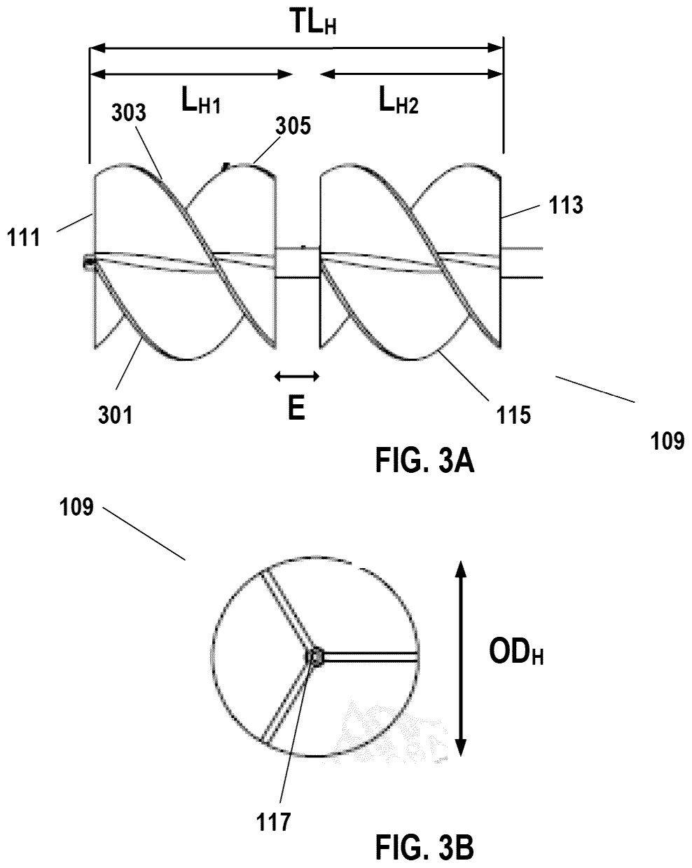

FIG. 3A includes a side-view illustration of the at least one helical body 109 configured to be disposed in the radiant tube proximate to the body 105 and configured to reduce the content of pollutants formed during combustion. FIG. 3B includes a cross-sectional illustration of the at least one helical body 109 according to an embodiment.

In one embodiment, the at least one helical body 109 may have a generally helical shape. The at least one helical body 109 may have a total length (TL_{H}) and an outer diameter (OD_{H}). In still another non-limiting embodiment, the at least one helical body 109 may include multiple helical bodies each having a length L_{H}. For example, in one non-limiting embodiment illustrated in FIG. 3A, the at least one helical body 109 includes a first helical body and a second helical body each having a length L_{H1}, and L_{H2}, respectively. In still another embodiment, the at least one helical body 109 may include a total length (TL_{H}) defining a total length of all the helical bodies from a proximal surface of the first helical body to a terminal surface of the last helical body. The total length (TL_{H}) can be defined as the total of all length of the helical bodies including axial distance (E). For example, as illustrated in the non-limiting embodiment illustrated in FIG. 3A, the TL_{H} of the at least one helical body 109 is equal to the sum of L_{H1}, L_{H2} and the axial distance (E). The outer diameter OD_{H} can be defined by the largest diameter value, which may include the extension of radial members from the at least one helical body 109. In one embodiment, the at least one helical body 109 can include a proximal surface 111, a terminal surface 113. In another embodiment, the at least one helical body 109 can include a central portion 117 that may extend for the total length (TL_{H}) of the at least one helical body 109.

In a further embodiment, the system may include multiple helical bodies that may be suitable for reducing pollutants. For example, in one non-limiting embodiment illustrated in FIG. 3A, the at least one helical body includes three helical bodies. In another non-limiting embodiment, the system may include at least one helical body, at least two helical bodies, or at least three helical bodies, or at least four helical bodies, or at least five helical bodies. In a further embodiment, the system may include not greater than ten helical bodies, not greater than nine helical bodies, or not greater than eight helical bodies, or not greater than seven helical bodies, or not greater than six helical bodies. In another embodiment, it will be understood that the number of helical bodies may be within a range between any number between at least 1 and not greater than 10.

In an embodiment, the at least one helical body 109 may include a length, L_{H}, that may facilitate improved performance of the system 100. For example, in one non-limiting embodiment, the at least one helical body 109 may include a length, L_{H}, of at least 10 mm, at least 20 mm, at least 30 mm, at least 40 mm, at least 50 mm, at least 60 mm, at least 70 mm, at least 80 mm, at least 90 mm, at least 100 mm, at least 110 mm, at least 120 mm, at least 130 mm, at least 140 mm, at least 150 mm. In still another non-limiting embodiment, the at least one helical body 109 may include a length, L_{H}, not greater than 200 mm, or not greater than 190 mm, or not greater than 180 mm, or not greater than 170 mm, or not greater than 160 mm. The length, L_{H}, of the at least one helical body 109 may be a value between any of the minimum and maximum values noted above, including for example, but not limited to within a range between 10 mm and not greater than 200 mm, or within a range between 20 mm in not greater than 190 mm, or within a range between 100 mm in not greater than 180 mm.

In an embodiment, the at least one helical body 109 may include an outer diameter of the body, OD_{H}, that may facilitate improved performance of the system 100. For example, in one non-limiting embodiment, the at least one helical body 109 may include an outer diameter of the body, OD_{H}, of at least 100 mm, or at least 110 mm, or at least 120 mm, or at least 130 mm, or at least 140 mm, or at least 150 mm, or at least 160 mm. In still another non-limiting embodiment, the at least one helical body 109 may include an outer diameter of the body, OD_{H}, not greater than not greater than 200 mm, or not greater than 190 mm, or not greater than 180 mm, or not greater than 170 mm. The outer diameter of the at least one helical body, OD_{H}, may be a value between any of the minimum and maximum values noted above, including for example, but not limited to within a range between 100 mm and not greater than 200 mm, or within a range between 110 mm in not greater than 190 mm, or within a range between 120 mm in not greater than 180 mm.

In an embodiment, the at least one helical body 109 may include an outer diameter of the body, OD_{H}, relative to the length of the at least one helical body L_{H} that may facilitate improved performance of the system 100. For example, in one non-limiting embodiment, the at least one helical body 109 may include an outer diameter of the body, OD_{H}, of at least 0.5 L_{H}, or at least 0.6 L_{H}, or at least 0.7 L_{H}, or at least 0.8 L_{H}, or at least 0.9 L_{H}, or at least 1 L_{H}, or at least 1.1 L_{H}. In still another non-limiting embodiment, the at least one helical body 109 may include an outer diameter of the body, OD_{H}, not greater than 3 L_{H}, or not greater than 2.5 L_{H}, or not greater than 2 L_{H}, or not greater than 1.5 L_{H}. The outer diameter of the at least one helical body, OD_{H}, may be a value between any of the minimum and maximum values noted above, including for example, but not limited to within a range between 0.5 L_{H} and not greater than 3 L_{H}, or within a range between 0.6 L_{H} in not greater than 2 L_{H} or within a range between 1 L_{H} in not greater than 1.5 L_{H}.

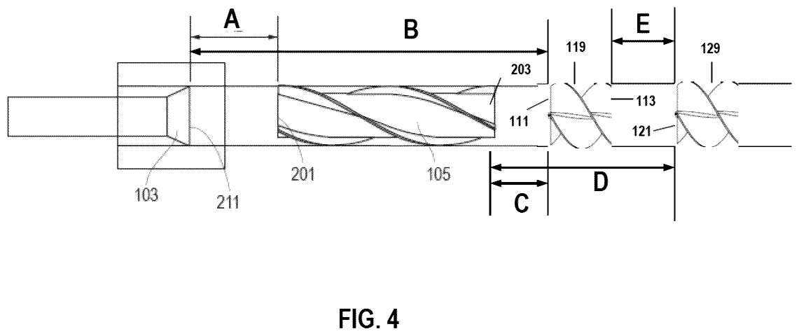

According to one embodiment, the body 105 and the at least one helical body 109 can be configured to be disposed in a particular location relative to the burner and to each other. In one embodiment, as illustrated in FIG. 4, the proximal end 201 of the body 105 may be disposed at a particular axial distance (A) from a terminal end 211 of the burner, which may facilitate improved reduction of pollutants. In yet another embodiment, the proximal end 111 of a first helical body 119 may be disposed at a particular axial distance (B) from a terminal end 211 of the burner which may facilitate improved reduction of pollutants. In still another embodiment, the terminal end 203 of the body 105 may be disposed at a particular axial distance (C) from a proximal end 111 of a first helical body 119 which may facilitate improved reduction of pollutants. In yet another embodiment, the terminal end 203 of the body 105 may be disposed at a particular axial distance (D) from a proximal end 121 of a second helical body 129 which may facilitate improved reduction of pollutants. In still another embodiment, the terminal end 113 of the first helical body 119 may be disposed at a particular axial distance (E) from a proximal end 121 of a second helical body 129 which may facilitate improved reduction of pollutants.

In a more particular embodiment, through empirical studies, it has been found that controlling the relationship between the axial distance (E) between a first helical body 119 and a second helical body 129 relative to the length (L_{H}) of the at least one helical body 109 may be suitable for reducing pollutants. For example, in one non-limiting embodiment, the axial distance (E) may be at least a 1% of the length (L_{H}) of the at least one helical body 109 [(E/L_{H})×100], such as at least 10%, or at least 50%, or at least 100%, or at least 150%, or at least 200%, or at least 250%, or at least 300%, or at least 350%. In still another non-limiting embodiment, the axial distance (E) may be not greater than 600% of the length (L_{H}) of the at least one helical body 109 [(E/L_{H})×100], or not greater than 550%, or not greater than 500%, or not greater than 450%, or not greater than 400%. In another embodiment, it will be understood that the axial distance (E) may be within a range between any percentage between at least 1% and not greater than 600%. For example, the axial distance (E) may be with a range of at least 1% and not greater than 600%, or at least 10% and not greater than 500%, or at least 50% and not greater than 400%.

In still another non-limiting embodiment, the axial distance (E) between a first helical body 119 and a second helical body 129 may be at least 50 mm, or at least 100 mm, or at least 150 mm, or at least 200 mm, or at least 250 mm, or at least 300 mm, or at least 350 mm, or at least 400 mm, or at least 450 mm, or at least 500 mm. In still another non-limiting embodiment, the axial distance (E) may be not greater than 800 mm, or not greater than 750 mm, or not greater than 700 mm, or not greater than 650 mm, or not greater than 600 mm, or not greater than 550 mm. In another embodiment, it will be understood that the axial distance (E) may be within a range between any number mentioned above, for example, within a range of at least 100 mm and not greater than 800 mm, or at least 150 and not greater than 750 mm, or at least 200 mm and not greater than 650 mm. In still another non-limiting embodiment, the axial distance (E) between a first helical body 119 and a second helical body 129 may effectively be zero where the terminal end 113 of the first helical body 119 and the proximal end 121 of the second helical body 129 are abutting.

In a more particular embodiment, through empirical studies, it has been found that controlling the relationship between the total length of a first helical body, L_{H1}, and the length of the second helical body, L_{H2}, relative to the length (L_{B}) of the body 105 may be suitable for reducing pollutants. For example, in one non-limiting embodiment, the total length of a first helical body, L_{H1}, and the length of the second helical body, L_{H2}, is at least 1% of the length (L_{B}) of the body [((L_{H1}+L_{H2})/L_{B})×100], such as at least 2%, or at least 3%, or at least 4%, or at least 5%, or at least 6%, or at least 7%, or at least 8%, or at least 9%, or at least 10%, or at least 11%, or at least 12%, or at least 13%, or at least 14%, or at least 15%, or at least 16%, or at least 17%, or at least 18%, or at least 19%, or at least 20%. In still another non-limiting embodiment, the total length of a first helical body, L_{H1}, and the length of the second helical body, L_{H2}, is not greater than 39% of the length (L_{B}) of the body [(L_{H}1+L_{H2})/L_{B})×100], such as or not greater than 38%, or not greater than 37% or not greater than 36%, or not greater than 35%, or not greater than 34%, or not greater than 33%, or not greater than 32%, or not greater than 31%, or not greater than 30%, or not greater than 29%, or not greater than 28%, or not greater than 27%, or not greater than 26%, or not greater than 25%. In another embodiment, it will be understood that the total length of a first helical body, L_{H1}, and the length of the second helical body, L_{H2}, relative to the length (L_{B}) may be within a range between any percentage between at least 1% and not greater than 40%. For example, the total length of a first helical body, L_{H1}, and the length of the second helical body, L_{H2}, may be at least 1% and not greater than 40% of the length (L_{B}) of the body, or at least 5% and not greater than 35%.

In a more particular embodiment, through empirical studies, it has been found that controlling the relationship between the axial distance (A) relative to the length (L_{B}) of the body 105 may be suitable for reducing pollutants. In one embodiment, the use of a body 105 having a solid wall as opposed to another construction (e.g., a mesh tube) may benefit from a particular spacing between the axial distance relative to the length of the body 105, which may be suitable to reduce pollutants. For example, in one non-limiting embodiment, the axial distance (A) may be at least a 0.1% of the length (L_{B}) of the body 105 [(A/L_{B})×100%], such as at least 1%, or at least 2%, or at least 3%, or at least 4%, or at least 5%, or at least 6%, or at least 7%, or at least 8%, or at least 9%, or at least 10%, or at least 15%, or at least 20%, or at least 25%, or at least 30%, or at least 35%, or at least 40%, or at least 45%, or at least 50%, or at least 55%, or at least 60%, or at least 65%, or at least 70%, or at least 75%, or at least 80%, or at least 85%, or at least 90%, or at least 95%, or at least 100%. In still another non-limiting embodiment, the axial distance (A) may be not greater than 900% of the length of the body L_{B}, such as not greater than 500% or not greater than 200% or not greater than 100% or not greater than 90% or not greater than 85% or not greater than 80% or not greater than 75% or not greater than 70% or not greater than 65% or not greater than 60% or not greater than 55% or not greater than 50% or not greater than 45% or not greater than 40% or not greater than 35%. In another non-limiting embodiment, the axial distance (A) may be within a range of at least 0.1% and not greater than 900% of the length L_{B} of the body 105. In another embodiment, it will be understood that the axial distance (A) may be within a range between any percentage between at least 0.1% and not greater than 900% of the length L_{B} of the body 105.

In a more particular embodiment, through empirical studies, it has been found that controlling the relationship between the axial distance (B) relative to the length (L_{H}) of the at least one helical body 109 may be suitable for reducing pollutants. For example, in one non-limiting embodiment, the axial distance (B) may be at least a 0.1% of the length (L_{H}) of the at least one helical body 109 [(B/L_{H})×100%], such as at least 1%, or at least 2%, or at least 3%, or at least 4%, or at least 5%, or at least 6%, or at least 7%, or at least 8%, or at least 9%, or at least 10%, or at least 15%, or at least 20%, or at least 25%, or at least 30%, or at least 35%, or at least 40%, or at least 45%, or at least 50%, or at least 55%, or at least 60%, or at least 65%, or at least 70%, or at least 75%, or at least 80%, or at least 85%, or at least 90%, or at least 95%, or at least 100%. In still another non-limiting embodiment, the axial distance (B) may be not greater than 900% of the length of the body L_{H}, such as not greater than 800% or not greater than 700% or not greater than 600% or not greater than 500% or not greater than 400% or not greater than 300% or not greater than 200% or not greater than 100% or not greater than 90% or not greater than 70% or not greater than 55% or not greater than 50% or not greater than 45% or not greater than 40% or not greater than 35%. In another non-limiting embodiment, the axial distance (B) may be within a range of at least 0.1% and not greater than 900% of the length L_{H} of the at least one helical body 109. In another embodiment, it will be understood that the axial distance (B) may be within a range between any percentage between at least 0.1% and not greater than 900% of the length L_{H} of the at least one helical body 109. In another non-limiting embodiment, the axial distance (B) is greater than an axial distance (A).

In a particular embodiment, through empirical studies, it has been found that controlling the axial distance (C) between a proximal end 111 of a first helical body 119 and the terminal end 203 of the body 105 may be suitable for reducing pollutants. For example, in one non-limiting embodiment, the axial distance (C) between a proximal end 111 of a first helical body 119 and the terminal end 203 of the body 105 may be at least 10 mm, or at least 20 mm, or at least 30 mm, or at least 40 mm, or at least 50 mm, or at least 60 mm, or at least 70 mm, or at least 80 mm, or at least 90 mm. In still another non-limiting embodiment, the axial distance (C) between a proximal end 111 of a first helical body 119 and the terminal end 203 of the body 105 may be not greater than 300 mm, or not greater than 250 mm, or not greater than 200 mm, or not greater than 150 mm, or not greater than 120 mm, or not greater than 110 mm. In another embodiment, the axial distance (C) may be a value between any of the minimum and maximum values noted above, including for example, but not limited to, within a range of at least 10 mm to not greater than 300 mm, or at least 20 mm to not greater than 250 mm, or at least 30 mm and not greater than 110 mm.

In a particular embodiment, through empirical studies, it has been found that controlling the axial distance (D) between a proximal end 121 of a second helical body 129 and the terminal end 203 of the body 105 may be suitable for reducing pollutants. For example, in one non-limiting embodiment, the axial distance (D) between a proximal end 121 of a second helical body 129 and the terminal end 203 of the body 105 may be at least 10 mm, or at least 20 mm, or at least 30 mm, or at least 40 mm, or at least 50 mm, or at least 60 mm, or at least 70 mm, or at least 80 mm, or at least 90 mm, or at least 100 mm, or at least 150 mm, or at least 200 mm or at least 250 mm, or at least 300 mm, or at least 350 mm, or at least 400 mm, or at least 450 mm, or at least 500 mm, or at least 550 mm, or at least 600 mm, or at least 650 mm, or at least 700 mm, or at least 750 mm. In still another non-limiting embodiment, the axial distance (D) between a proximal end 121 of a second helical body 129 and the terminal end 203 of the body 105 may be not greater than 1200 mm, or not greater than 1100 mm, or not greater than 1000 mm, or not greater than 950 mm, or not greater than 900 mm, or not greater than 850 mm, or not greater than 800 mm. In another embodiment, the axial distance (D) may be a value between any of the minimum and maximum values noted above, including for example, but not limited to, within a range of at least 10 mm to not greater than 1200 mm, or at least 20 mm to not greater than 900 mm, or at least 600 mm and not greater than 800 mm. In another non-limiting embodiment, the axial distance (D) is greater than an axial distance (C).

According to one embodiment, the body 105 may include one or more optional radial members extending radially outward from the outer circumferential surface 205. Referring to the non-limiting embodiment of FIG. 2A, the body 105 includes radial members 221, 222, and 223, (221-223) that extend along the exterior circumferential surface 205 of the body 105. The radial members 221-223 may extend in a non-linear path along the exterior circumferential surface 205, which has both axial and circumferential components defining the pathway. According to one particular embodiment, one or more of the radial members 221-223 may extend in a helical pathway along the circumferential surface 205. In still another non-limiting embodiment, the one or more radial members 221-223 may extend in a helical path with a variable twist, such that the angle of the twist may change along a length of the body 105.

While not illustrated, in another embodiment, one or more optional radial members may extend radially inward from the inner annular surface 209, such that the one or more radial members extend into the central axial opening 207. The one or more radial members may assist with control of the flow of fluids through and around the body 105, which may facilitate reduction in pollutants.

According to one embodiment, the body 105 can have at least one radial member that extends radially outward from the outer circumferential surface 205 that extends for a radial distance (RD) of at least 0.1% of the inner diameter (ID) of the body 105 [(RD/ID)×100%] such as at least 1%, or at least 2%, or at least 3%, or at least 4%, or at least 5%, or at least 6%, or at least 7%, or at least 8%, or at least 9%, or at least 10%, or at least 15%, or at least 20%, or at least 25%, or at least 30%, or at least 35%, or at least 40%, or at least 45%, or at least 50%, or at least 55%, or at least 60%, or at least 65%, or at least 70%, or at least 75%, or at least 80%, or at least 85%, or at least 90%, or at least 95%, or at least 100%. In still another non-limiting embodiment, the radial distance may be not greater than 900% of the inner diameter (ID) of the body 105, such as not greater than 500% or not greater than 200% or not greater than 100% or not greater than 90% or not greater than 85% or not greater than 80% or not greater than 75% or not greater than 70% or not greater than 65% or not greater than 60% or not greater than 55% or not greater than 50% or not greater than 45% or not greater than 40% or not greater than 35%. In another embodiment, it will be understood that the radial distance may be within a range between any percentage between at least 0.1% and not greater than 900% of the inner diameter of the body 105.

In yet another non-limiting embodiment, the body 105 can have at least one radial member that extends radially inward from the inner annular surface 209 that may extend for a radial distance (RD) of at least 0.1% of the inner diameter (ID) of the body 105 [(RD/ID)×100%] such as at least 1% or at least 2% or at least 3% or at least 4% or at least 5% or at least 6% or at least 7% or at least 8% or at least 9% or at least 10% or at least 15% or at least 20% or at least 25% or at least 30% or at least 35% or at least 40% or at least 45% or at least 50% or at least 55% or at least 60% or at least 65% or at least 70% or at least 75% or at least 80% or at least 85% or at least 90% or at least 95% or at least 100%. In still another non-limiting embodiment, the radial distance may be not greater than 900% of the inner diameter (ID) of the body 105, such as not greater than 500% or not greater than 200% or not greater than 100% or not greater than 90% or not greater than 85% or not greater than 80% or not greater than 75% or not greater than 70% or not greater than 65% or not greater than 60% or not greater than 55% or not greater than 50% or not greater than 45% or not greater than 40% or not greater than 35%. In another embodiment, it will be understood that the radial distance may be within a range between any percentage between at least 0.1% and not greater than 900% of the inner diameter of the body 105.

In certain non-limiting instances, the at least one radial member may extend around the outer circumferential surface 205 and/or inner annular surface 209 of the body 105 for a given distance as measured by degrees through which the at least one radial member extends between a proximal end of the radial member and a terminal end of a radial member. For example, one complete turn of the radial member around the entire circumference of the body would be measured as an angle of 360 degrees. According to one embodiment, the at least one radial member extends for a circumferential distance of at least 1 degree on the inner annular surface or outer circumferential surface of the body 105. In other non-limiting instances, the circumferential distance can be greater, such as at least 10 degrees or at least 30 degrees or at least 60 degrees or at least 90 degrees or at least 180 degrees or at least 270 degrees or at least 360 degrees. In one non-limiting instance, the body 105 can have one or more radial members extending for a distance within a range of at least 1 degree and not greater than 3600 degrees.

In one non-limiting embodiment, the one or more radial members may be solid members. That is, the one or more radial members do not necessarily contain internal cavities configured for the flow of fluids (e.g., gasses) therethrough.

According to one embodiment, the at least one helical body 109 may include one or more radial members extending radially outward from the central portion 117. Referring to the non-limiting embodiment of FIG. 3A, the at least one helical body 109 includes radial members 301, 303, and 305, (301-305) that extend along the central portion 117 of the at least one helical body 109. The radial members 301-305 may extend in a non-linear path along the central portion 117, which has both axial and circumferential components defining the pathway. According to one particular embodiment, one or more of the radial members 301-305 may extend in a helical pathway along the central portion 117.

In certain non-limiting instances, the at least one radial member 301-305 may extend around the central portion 117 of the at least one helical body 109 for a given distance as measured by degrees through which the at least one radial member 301-305 extends between a proximal end of the radial member and a terminal end of a radial member. For example, one complete turn of the radial member around the entire circumference of the at least one helical body 109 would be measured as an angle of 360 degrees. According to one embodiment, the at least one radial member 301-305 extends for a circumferential distance of at least 1 degree on the central portion 117 of the at least one helical body 109. In other non-limiting instances, the circumferential distance can be greater, such as at least 10 degrees or at least 30 degrees or at least 60 degrees or at least 90 degrees or at least 180 degrees or at least 270 degrees or at least 360 degrees. In one non-limiting instance, the at least one helical body 109 can have one or more radial members extending for a distance within a range of at least 1 degree and not greater than 3600 degrees.

In still another non-limiting embodiment, the one or more radial members 301-305 may extend in a helical path defining a pitch of the at least one helical body 109. As used herein, the pitch of the at least one helical body 109 is used to describe the length the at least one radial member 301-305 extends between a proximal end 111 and a terminal end 113 of the at least one helical body 109 for one complete turn of the at least one radial member around the central portion 117 of the at least one helical body 109 (i.e. 360 degrees). In an embodiment, the length can be measured parallel to the total length, TL_{H}, of the at least one helical body 109. For example, a helical body having a pitch of 300 mm would mean the radial members of the helical body would take 300 mm along the length extending between a proximal end 111 and a terminal end 113 of the helical body to complete a full 360 degree twist along the central portion 117. In one non-limiting embodiment, the at least one helical body 109 may have a pitch of at least 10 mm, such as at least 20 mm, or at least 30 mm, or at least 40 mm, or at least 50 mm, or at least 75 mm, or at least 100 mm, or at least 125 mm, or at least 150 mm, or at least 175 mm, or at least 200 mm, or at least 225 mm, or at least 250 mm, or at least 275 mm, or at least 300 mm, or at least 325 mm, or at least 350 mm, or at least 370 mm, or at least 380 mm, or at least 390 mm, or at least 400 mm, or at least 425 mm, or at least 450 mm, or at least 475 mm, or at least 500 mm, or at least 550 mm, or at least 600 mm, or at least 650 mm, or at least 700 mm, or at least 750 mm, or at least 800 mm. In still other non-limiting embodiments, the at least one helical body 109 may have a pitch not greater than 5000 mm, such as not greater than 4000 mm, or not greater than 3000 mm, or not greater than 2000 mm, or not greater than 1000 mm, or not greater than 900 mm. In another embodiment, the pitch of the at least one helical body 109 may be a value between any of the minimum and maximum values noted above, including for example, but not limited to, within a range of at least 10 mm and not greater than 5000 mm, or at least 150 mm and not greater than 1000 mm, or at least 350 mm and not greater than 900 mm.

In one non-limiting embodiment, when the system 100 has more than one helical body, the pitches of the helical body may be different relative to each other. For example, in one non-limiting embodiment illustrated in FIG. 4, the first helical body 119 may have a pitch higher than the pitch of the second helical body 129. In another non-limiting embodiment, the first helical 119 body may have a pitch lower than the pitch of the second helical body 129. In still another embodiment, the pitch of the first helical body 119 and the second helical 129 may be the same. In one non-limiting embodiment, the pitch of the first helical body may be at least 1% greater than a pitch of the second helical body, such as at least 2% larger, or at least 3%, or at least 4%, or at least 5%, or at least 10%, or at least 20%, or at least 30%, or at least 40%, or at least 50%, or at least 60%, or at least 70%, or at least 80%, or at least 90% or at least 100%, or at least 110, or at least 120%, or at least 130%, or at least 140%, or at least 150%, or at least 160%, or at least 170%, or at least 180%, or at least 190%, or at least 200%. In still other embodiment, the pitch of the first helical body may not greater than 1000% greater than a pitch of the second helical body, such as not greater than 900%, or not greater than 800%, or not greater than 700%, or not greater than 600%, or not greater than 500%, or not greater than 400%, or not greater than 300%, or not greater than 250%. In another embodiment, the percentage may be a value between any of the minimum and maximum values noted above, including for example, but not limited to, within a range of at 1% and not greater than 1000%, or at least 40% and not greater than 400%, or at least 50% and not greater than 250%.

In one non-limiting embodiment, the body 105 and the at least one helical body 109 can include a ceramic material. In one particular instance, the body and the at least one helical body may include an oxide, carbide, nitride, or any combination thereof. In one embodiment, the body and the at least one helical body may include a carbide, such as silicon carbide. In one particular embodiment, the body and the at least one helical body consist essentially of a ceramic, such as consisting essentially of a carbide, and more particularly, may consist essentially of silicon carbide. In one embodiment, the body and the at least one helical body may include different materials.

In a further embodiment, the material of the body 105 and the at least one helical body 109 may have a particular density that may facilitate improved manufacturing and/or operation. For example, the material of the body 105 and the at least one helical body 109 may have an average density of at least 2.50 g/cm³, such as at least 2.55 g/cm³, or at least 2.57 g/cm³, or at least 2.60 g/cm³, or at least 2.70 g/cm³. In a further embodiment, the average density of the material of the body and the at least one helical body may be not greater than 2.9 g/cm³, or not greater than 2.8 g/cm³, or not greater than 2.75 g/cm³. Moreover, the average density of the material of the body and the at least one helical body can be within a range including any of the minimum and maximum values noted above. In one embodiment, the body and the at least one helical body may have different average densities.

According to one embodiment, the system 100 may reduce the content of pollutants (e.g., NOx) by at least 10%, such as at least 12% or at least 15% or at least 18% or at least 20% or at least 25% or at least 30% as compared to state-of-the-art systems that do not use a combination of the body 105 and the at least one helical body 109 or have other less desirable configurations. In one non-limiting embodiment, the system 100 can reduce the content of pollutants by not greater than 100% or not greater than 80% or not greater than 60%. It will be appreciated that the reduction in the content of pollutants can be within a range including any of the minimum and maximum percentages noted above.

In still other embodiments, measuring the pollutants may include measuring a content of nitrogen oxides (NOx). It will be appreciated that the content of nitrogen oxides (NOx) can be measured using methods known to those skilled in the art. In another non-limiting embodiment, the method for reducing pollutants of a combustion assembly may further include reducing the nitrogen oxide (NOx) content by at least 10%, such as at least 12% or at least 15% or at least 18% or at least 20% or at least 25% or at least 30%.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

### EMBODIMENTS

Embodiment 1. A system configured to be installed into a radiant tube for reduction of pollutants, the system comprising:
a body having a tube shape including a length L_{B}, an outer diameter OD_{B}, and an inner diameter ID_{B}, wherein the body further comprises a proximal surface, a terminal surface, and a circumferential surface extending between the proximal surface and terminal surface;
at least two helical bodies each having a substantially helical shape including a length L_{H}, and an outer diameter OD_{H}, wherein an axial distance (E) between the at least two helical bodies is at least 1% of the length L_{H}.

Embodiment 2. A system configured to be installed into a radiant tube for reduction of pollutants, the system comprising:
a body having a tube shape including a length L_{B}, an outer diameter OD_{B}, and an inner diameter ID_{B}, wherein the body further comprises a proximal surface, a terminal surface, and a circumferential surface extending between the proximal surface and terminal surface;
a first helical body closest to the body and a second helical body each having a substantially helical shape including a length L_{H}, an outer diameter OD_{H}, and a pitch, wherein the pitch of the first helical body and the second helical body are different.

Embodiment 3. A system configured to be installed into a radiant tube for reduction of pollutants, the system comprising:
a body having a tube shape including a length L_{B}, an outer diameter OD_{B}, and an inner diameter ID_{B}, wherein the body further comprises a proximal surface, a terminal surface, and a circumferential surface extending between the proximal surface and terminal surface;
a first helical body closest to the body and a second helical body each having a substantially helical shape including a length L_{H}, an outer diameter OD_{H}, wherein the total length of a first helical body, L_{H1}, and the length of the second helical body, L_{H2}, is not greater than 40% L_{B}.

Embodiment 4. The system of any one of embodiments 1, 2, or 3, wherein the length of body, L_{B}, is at least 100 mm, or at least 200 mm, or at least 300 mm, or at least 350 mm, or at least 400 mm, or at least 450 mm, or at least 500 mm, or at least 600 mm, or at least 650 mm, at least 700 mm, at least 750 mm, or at least 800 mm, or at least 850 mm, or at least 900 mm.

Embodiment 5. The system of any one of embodiments 1, 2, or 3, wherein the length of body, L_{B}, is not greater than 1200 mm, or not greater than 1150 mm, or not greater than 1100 mm, or not greater than 1000 mm, or not greater than 950 mm.

Embodiment 6. The system of any one of embodiments 1, 2, or 3, wherein the outer diameter of the body, OD_{B}, is at least 70 mm, or at least 80 mm, or at least 90 mm, or at least 100 mm, or at least 110 mm, or at least 120 mm, or at least 130 mm, or at least 140 mm, or at least 150 mm.

Embodiment 7. The system of any one of embodiments 1, 2, or 3, wherein the outer diameter of the body, OD_{B}, is not greater than 300 mm, or not greater than 275 mm, or not greater than 250 mm, or not greater than 225 mm, or not greater than 200 mm, or not greater than 190 mm, or not greater than 180 mm, or not greater than 170 mm, or not greater than 160 mm.

Embodiment 8. The system of any one of embodiments 1, 2, or 3, wherein the outer diameter of the body, OD_{B}, is at least 0.01 L_{B}, or at least 0.05 L_{B}, or at least 0.1 L_{B}, or at least 0.15 L_{B}.

Embodiment 9. The system of any one of embodiments 1, 2, or 3, wherein the outer diameter of the body, OD_{B}, is not greater than 1 L_{B}, or not greater than 0.9 L_{B}, or not greater than 0.8 L_{B}, or not greater than 0.7 L_{B}, or not greater than 0.6 L_{B}, or not greater than 0.5 L_{B}, or not greater than 0.4 L_{B}, or not greater than 0.3 L_{B}, or not greater than 0.2 L_{B}.

Embodiment 10. The system of any one of embodiments 1, 2, or 3, wherein the inner diameter of the body, ID_{B}, is at least 10 mm, or at least 20 mm, or at least 30 mm, or at least 40 mm, or at least 45 mm, or at least 50 mm, or at least 45 mm or at least 60 mm.

Embodiment 11. The system of any one of embodiments 1, 2, or 3, wherein the inner diameter of the body, ID_{B}, is not greater than 90 mm, or not greater than 85 mm, or not greater than 80 mm, or not greater than 75 mm, or not greater than 70 mm.

Embodiment 12. The system of any one of embodiments 1, 2, or 3, wherein the inner diameter of the body, ID_{B}, is at least 0.01 L_{B}, or at least 0.02 L_{B}, or at least 0.03 L_{B}, or at least 0.04 L_{B}, or at least 0.05 L_{B}, or at least 0.06 L_{B}, or at least 0.07 L_{B}.

Embodiment 13. The system of any one of embodiments 1, 2, or 3, wherein the inner diameter of the body, ID_{B}, is not greater than 0.5 L_{B}, or not greater than 0.45 L_{B}, or not greater than 0.4 L_{B}, or not greater than 0.35 L_{B}, or not greater than 0.3 L_{B}, or not greater than 0.25 L_{B}, or not greater than 0.2 L_{B}, or not greater than 0.15 L_{B}, or not greater than 0.1 L_{B}.

Embodiment 14. The system of any one of embodiments 1, 2, or 3, wherein the body comprises a wall thickness, T_{B}, wherein the wall thickness is defined as the difference between the outer diameter OD_{B} and inner diameter ID_{B}.

Embodiment 15. The system of embodiment 14, wherein the wall thickness, T_{B}, is at least 0.1 mm, or at least 0.2 mm, or at least 0.3 mm, or at least 0.4 mm, or at least 0.5 mm, or at least 0.6 mm, or at least 0.7 mm, or at least 0.8 mm, or at least 0.9 mm, or at least 1 mm, or at least 1.1 mm or at least 1.2 mm, or at least 1.3 mm, or at least 1.4 mm, or at least 1.5 mm, or at least 1.6 mm, or at least 1.7 mm, or at least 1.8 mm, or at least 1.9 mm, or at least 2 mm.

Embodiment 16. The system of embodiment 14, wherein the wall thickness, T_{B}, is not greater than 6 mm, or not greater than 5 mm, or not greater than 4 mm, or not greater than 3 mm, or not greater than 2.5 mm.

Embodiment 17. The system of embodiment 14, wherein the wall thickness, T_{B}, is at least 0.01 ID_{B}, or at least 0.015 ID_{B}, or at least 0.02 ID_{B}, or at least 0.025 ID_{B}.

Embodiment 18. The system of embodiment 14, wherein the wall thickness, T_{B}, is not greater than 0.2 ID_{B}, or not greater than 0.15 ID_{B}, or not greater than 0.1 ID_{B}, or not greater than 0.09 ID_{B}, or not greater than 0.085 ID_{B}, or not greater than 0.08 ID_{B}.

Embodiment 19. The system of any one of embodiments 1, 2, or 3, wherein the length of the at least one helical body, the first helical body or the second helical body, L_{H}, is at least 10 mm, at least 20 mm, at least 30 mm, at least 40 mm, at least 50 mm, at least 60 mm, at least 70 mm, at least 80 mm, at least 90 mm, at least 100 mm, at least 110 mm, at least 120 mm, at least 130 mm, at least 140 mm, at least 150 mm.

Embodiment 20. The system of any one of embodiments 1, 2, or 3, wherein the length of the at least one helical body, the first helical body or the second helical body, L_{H}, is not greater than 200 mm, or not greater than 190 mm, or not greater than 180 mm, or not greater than 170 mm, or not greater than 160 mm.

Embodiment 21. The system of embodiment 3, wherein the total length of a first helical body, L_{H1}, and the length of the second helical body, L_{H2}, is at least 1% of the length (L_{B}) of the body, or at least 2%, or at least 3%, or at least 4%, or at least 5%, or at least 6% or at least 7% or at least 8% or at least 9% or at least 10% or at least 11% or at least 12% or at least 13% or at least 14% or at least 15% or at least 16% or at least 17% or at least 18% or at least 19% or at least 20%.

Embodiment 22. The system of embodiment 3, wherein the total length of a first helical body, L_{H1}, and the length of the second helical body, L_{H2}, is not greater than 39% of the length (L_{B}) of the body, or not greater than 38%, or not greater than 37%, or not greater than 36%, or not greater than 35%, or not greater than 34%, or not greater than 33%, or not greater than 32%, or not greater than 31%, or not greater than 30%, or not greater than 29%, or not greater than 28%, or not greater than 27%, or not greater than 26%, or not greater than 25%.

Embodiment 23. The system of any one of embodiments 1, 2, or 3, wherein the outer diameter of the at least one helical body, the first helical body or the second helical body, OD_{H}, is at least 100 mm, or at least 110 mm, or at least 120 mm, or at least 130 mm, or at least 140 mm, or at least 150 mm, or at least 160 mm.

Embodiment 24. The system of any one of embodiments 1, 2, or 3, wherein the outer diameter of the at least one helical body, the first helical body or the second helical body, OD_{H}, is not greater than not greater than 200 mm, or not greater than 190 mm, or not greater than 180 mm, or not greater than 170 mm.

Embodiment 25. The system of any one of embodiments 1, 2, or 3, wherein the outer diameter of the at least one helical body, the first helical body or the second helical body, OD_{H}, is at least 0.5 L_{H}, or at least 0.6 L_{H}, or at least 0.7 L_{H}, or at least 0.8 L_{H}, or at least 0.9 L_{H}, or at least 1 L_{H}, or at least 1.1 L_{H}.

Embodiment 26. The system of any one of embodiments 1, 2, or 3, wherein the outer diameter of the at least one helical body, the first helical body or the second helical body, OD_{H}, is not greater than 3 L_{H}, or not greater than 2.5 L_{H}, or not greater than 2 L_{H}, or not greater than 1.5 L_{H}.

Embodiment 27. The system of embodiment 1, wherein an axial distance (E) between the first helical body and the second helical body is at least 1% of the length (L_{H}) of the at least one helical body, or at least 10%, or at least 50%, or at least 100%, or at least 150%, or at least 200%, or at least 250%, or at least 300%, or at least 350%.

Embodiment 28. The system of embodiment 1, wherein an axial distance (E) between the first helical body and the second helical body is not greater than 600% of the length (L_{H}) of the at least one helical body, or not greater than 550%, or not greater than 500%, or not greater than 450%, or not greater than 400%.

Embodiment 29. The system of embodiment 1, wherein the body is configured to be disposed at an axial distance (A) from a terminal end of a burner.

Embodiment 30. The system of embodiment 29, wherein the axial distance (A) is at least 0.1% of the length (L_{B}) of the body, or at least 1% or at least 2% or at least 3% or at least 4% or at least 5% or at least 6% or at least 7% or at least 8% or at least 9% or at least 10% or at least 15% or at least 20% or at least 25% or at least 30% or at least 35% or at least 40% or at least 45% or at least 50% or at least 55% or at least 60% or at least 65% or at least 70% or at least 75% or at least 80% or at least 85% or at least 90% or at least 95% or at least 100%.

Embodiment 31. The system of embodiment 29, wherein the axial distance (A) is not greater than 900% of the length (L_{B}) of the body, such as not greater than 500% or not greater than 200% or not greater than 100% or not greater than 90% or not greater than 85% or not greater than 80% or not greater than 75% or not greater than 70% or not greater than 65% or not greater than 60% or not greater than 55% or not greater than 50% or not greater than 45% or not greater than 40% or not greater than 35%.

Embodiment 32. The system of embodiment 29, wherein the at least two helical bodies are configured to be disposed at an axial distance (B) from a terminal end of a burner, wherein B>A.

Embodiment 33. The system of embodiment 32, wherein the axial distance (B) is at least a 0.1% of the length (L_{H}) of the at least one helical body, or at least 1% or at least 2% or at least 3% or at least 4% or at least 5% or at least 6% or at least 7% or at least 8% or at least 9% or at least 10% or at least 15% or at least 20% or at least 25% or at least 30% or at least 35% or at least 40% or at least 45% or at least 50% or at least 55% or at least 60% or at least 65% or at least 70% or at least 75% or at least 80% or at least 85% or at least 90% or at least 95% or at least 100%.

Embodiment 34. The system of embodiment 32, wherein the axial distance (B) is not greater than 900% of the length of the body L_{H}, such as not greater than 800% or not greater than 700% or not greater than 600% or not greater than 500% or not greater than 400% or not greater than 300% or not greater than 200% or not greater than 100% or not greater than 90% or not greater than 70% or not greater than 55% or not greater than 50% or not greater than 45% or not greater than 40% or not greater than 35%.

Embodiment 35. The system of embodiment 1, wherein a first helical body is disposed at an axial distance (C) from the terminal surface of the body and wherein a second helical body is disposed at an axial distance (D) from the terminal surface of the body, wherein D>C.

Embodiment 36. The system of embodiment 35, wherein the axial distance (C) is at least 10 mm, or at least 20 mm, or at least 30 mm, or at least 40 mm, or at least 50 mm, or at least 60 mm, or at least 70 mm, or at least 80 mm, or at least 90 mm.

Embodiment 37. The system of embodiment 35, wherein the axial distance (C) is not greater than 300 mm, or not greater than 250 mm, or not greater than 200 mm, or not greater than 150 mm, or not greater than 120 mm, or not greater than 110 mm.

Embodiment 38. The system of embodiment 35, wherein the axial distance (D) is at least 10 mm, or at least 20 mm, or at least 30 mm, or at least 40 mm, or at least 50 mm, or at least 60 mm, or at least 70 mm, or at least 80 mm, or at least 90 mm, or at least 100 mm, or at least 150 mm, or at least 200 mm or at least 250 mm, or at least 300 mm, or at least 350 mm, or at least 400 mm, or at least 450 mm, or at least 500 mm, or at least 550 mm, or at least 600 mm, or at least 650 mm, or at least 700 mm, or at least 750 mm.

Embodiment 39. The system of embodiment 35, wherein the axial distance (D) is not greater than 1200 mm, or not greater than 1100 mm, or not greater than 1000 mm, or not greater than 950 mm, or not greater than 900 mm, or not greater than 850 mm, or not greater than 800 mm.

Embodiment 40. The system of embodiment 1, wherein an axial distance (E) between a first helical body and a second helical body is at least at least 50 mm, or at least 100 mm, or at least 150 mm, or at least 200 mm, or at least 250 mm, or at least 300 mm, or at least 350 mm, or at least 400 mm, or at least 450 mm, or at least 500 mm.

Embodiment 41. The system of embodiment 1, wherein an axial distance (E) between a first helical body and a second helical body is not greater than 800 mm, or not greater than 750 mm, or not greater than 700 mm, or not greater than 650 mm, or not greater than 600 mm, or not greater than 550 mm.

Embodiment 42. The system of embodiment 2, wherein the first helical body comprises a pitch greater than a pitch of the second helical body.

Embodiment 43. The system of embodiment 2, wherein the pitch of the first helical body is at least 390 mm, or at least 400 mm, or at least 425 mm, or at least 450 mm, or at least 475 mm, or at least 500 mm, or at least 550 mm, or at least 600 mm, or at least 650 mm, or at least 700 mm, or at least 750 mm, or at least 800 mm.

Embodiment 44. The system of embodiment 2, wherein the pitch of the first helical body is not greater than 5000 mm, such as not greater than 4000 mm, or not greater than 3000 mm, or not greater than 2000 mm, or not greater than 1000 mm, or not greater than 900 mm.

Embodiment 45. The system of embodiment 2, wherein the pitch of the second helical body is at least 10 mm, such as at least 20 mm, or at least 30 mm, or at least 40 mm, or at least 50 mm, or at least 75 mm, or at least 100 mm, or at least 125 mm, or at least 150 mm, or at least 175 mm, or at least 200 mm, or at least 225 mm, or at least 250 mm, or at least 275 mm, or at least 300 mm, or at least 325 mm, or at least 350 mm, or at least 370 mm, or at least 380 mm.

Embodiment 46. The system of embodiment 2, wherein the pitch of the second helical body is not greater than 5000 mm, such as not greater than 4000 mm, or not greater than 3000 mm, or not greater than 2000 mm, or not greater than 1000 mm, or not greater than 900 mm.

Embodiment 47. The system of embodiment 42, wherein the pitch of the first helical body is at least 1% greater than a pitch of the second helical body, or at least 2% larger, or at least 3%, or at least 4%, or at least 5%, or at least 10%, or at least 20%, or at least 30%, or at least 40%, or at least 50%, or at least 60%, or at least 70%, or at least 80%, or at least 90% or at least 100%, or at least 110, or at least 120%, or at least 130%, or at least 140%, or at least 150%, or at least 160%, or at least 170%, or at least 180%, or at least 190%, or at least 200%.

Embodiment 48. The system of embodiment 42, wherein the pitch of the first helical body is not greater than 1000% greater than a pitch of the second helical body, or not greater than 900%, or not greater than 800%, or not greater than 700%, or not greater than 600%, or not greater than 500%, or not greater than 400%, or not greater than 300%, or not greater than 250%.

Embodiment 49. The system of embodiment 2, wherein the first helical body and the second helical body comprise at least one radial member extending around a central portion of the body.

Embodiment 50. The system of embodiment 49, wherein the at least one radial member extends for a circumferential distance of at least 1 degree on the central portion of the body, or at least 10 degrees or at least 30 degrees or at least 60 degrees or at least 90 degrees or at least 180 degrees or at least 270 degrees or at least 360 degrees.

Embodiment 51. The system of embodiment 3, wherein the total length, TL_{H}, of the first and second helical bodies is at least 0.05 L_{B}, at least 0.1 L_{B}, or at least 0.15 L_{B}, or at least 0.2 L_{B}, or at least 0.25 L_{B}, or at least 0.3 L_{B}.

### Examples

A system was formed according to an embodiment including a radiant tube having a body and at least one helical body as described herein to determine the effect of spacing between the body and helical bodies, the length/number of helical bodies, and the pitch of the helical bodies on NOx reduction while eliminating hot spots in the radiant tube surface temperature. The system was composed of one straight radiant tube (alloy RA330, nominal outer diameter=178 mm, inner diameter=168 mm, overall length=3000 mm), a partial premix burner, refractory insulating brick, and peripheral plumbing for transporting inlet air, inlet gas, and exhaust flows. The burner (Fives, model #4725) was installed on a reduced diameter section of the radiant tube (outer diameter=114 mm, inner diameter=102 mm, length=490 mm). The nominal diameter section fills the remaining tube length (length=2510 mm). Flow meters outside the system monitor ambient temperature inlet air and natural gas flow rates delivered to the burner, from which the air:fuel ratio (AFR) is readily determined. Thermocouples were fixed to the exterior surface of the radiant tube into pre-drilled holes with high temperature cement at every 200 mm along the radiant tube length to measure the radiant tube temperature uniformity. Additionally, two thermocouples positioned centrally in the space between the radiant tube refractory wall were used to monitor the effect “furnace temperature.” A data logger recorded the radiant tube temperatures every 5 seconds. A combustion flue gas analyzer was used to measure exhaust gas composition (NO, O2, CO2, CO) and temperature at the radiant tube exhaust outlet at approximately 30 minutes intervals throughout tests. The flue gas analyzer was also used to measure combustion efficiency (lower heating value basis, LHV). Furnace firing and ceramic insert performance were tested by first, achieving ignition, then the burner power is gradually ramped from 10 KW to the desired firing rate (typically, 73 kW) in 20 minutes at constant AFR (11.5:1). Second, the AFR was adjusted to obtain 3% excess, dry oxygen in the exhaust gas. Firing continues for approximately three hours during which time the radiant tube and furnace achieve a quasi-steady reading. The AFR ratio was periodically adjusted to maintain 3% excess, dry oxygen in the exhaust gas.

### Length/Number of Bodies

A first comparative system, CS1, was made having no body or helical bodies. A second system, S2, was made according to an embodiment having a body and one helical body. A third system, S3, was made according to an embodiment having a body and two helical bodies. The dimensions and spacings of S2 and S3 are summarized in Table 1 below. NOx measurements were taken using a Bacharach PCA400, +/−ppm, portable combustion analyzer. The measurements were recording after obtaining a steady reading (within 30-60 seconds) and corrected for 3% excess oxygen from the actual probe oxygen concentration (ρo₂d) using the formula:

$$( [ {NO}_{x} @ 3 \% , ppm ] = [ {NO}_{x} @ {ρ}_{{O}_{2} d} , ppm ] \times \frac{20.9 - 3}{20.9 - {ρ}_{{O}_{2} d}} ] )$$

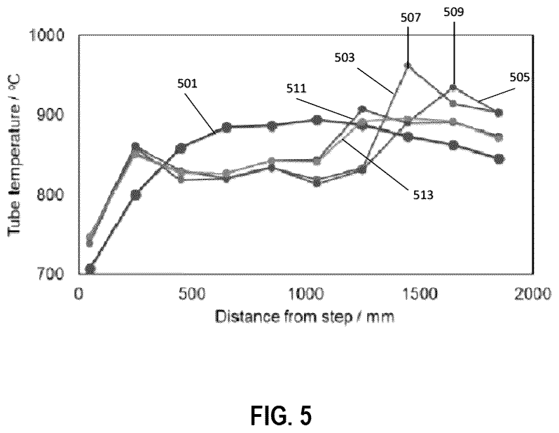

The measurements are summarized in Table 1. The radiant tube surface temperature of samples CS1, S2, and S3 were measured by placing Type-K thermocouple probes by Omega Engineering, +/−0.75%, inside the radiant tubes just adjacent to the inside radiant tube wall according to the construction detailed above and signals were logged using Graphtec GL820 logging equipment. The radiant tube temperatures of CS1, S2 and S3 can be seen in FIG. 5 as 501, 503, and 505, respectively.

TABLE 1

| | | | | | | | | Pitch of | Pitch of | |
|---|---|---|---|---|---|---|---|---|---|---|
| | Axial | | | | | Axial | Axial | first | second | NOx |
| | Distance | | | | | Distance | Distance | helical | helical | @ 3% |
| Sample | (A) | L_{B} | TL_{H} | L_{H1} | L_{H2} | (C) | (E) | body | body | O₂/ppm |
| CS1 | — | — | — | — | — | — | — | — | — | 77 |
| S2 | 156 mm | 905 mm | 610 mm | 610 mm | — | 337 mm | — | 381 mm | — | 33 |
| S3 | 156 mm | 905 mm | 610 mm | 155 mm | 155 mm | 337 mm | 300 mm | 381 mm | 381 mm | 36 |

As can be seen in the graph in FIG. 5, although samples S2 and S3 showed a reduction of NOx when compared to CS1, significant hotspots are shown at 507 and 509.

### Spacing of Bodies

A system S4 was made according to an embodiment having a body and two helical bodies, however the spacing between the bodies was manipulated when compared to sample S3. The measurements of sample S4 are summarized in Table 2. The radiant tube surface temperature and NOx were measured as described above with respect to CS1, S2, and S3 and can be seen in FIG. 5 labeled 511.

TABLE 2

| | | | | | | | | Pitch of | Pitch of | |
|---|---|---|---|---|---|---|---|---|---|---|
| | Axial | | | | | Axial | Axial | first | second | NOx |
| | Distance | | | | | Distance | Distance | helical | helical | @ 3% |
| Sample | (A) | L_{B} | TL_{H} | L_{H1} | L_{H2} | (C) | (E) | body | body | O₂/ppm |
| S4 | 156 mm | 905 mm | 857 mm | 155 mm | 155 mm | 100 mm | 547 mm | 381 mm | 381 mm | 36 |

As can be seen in the graph in FIG. 5, sample S4 showed a reduction of NOx when compared to CS1 with a reduction in hot spot activity.

### Pitch of Helical Bodies

A system S5 was made according to an embodiment having a body and two helical bodies, however the pitch of the bodies were manipulated when compared to sample S4. The measurements of sample S5 are summarized in Table 3. The radiant tube surface temperature and NOx were measured as described above with respect to CS1, S2, and S3 and can be seen in FIG. 5 labeled 513.

TABLE 3

| | | | | | | | | Pitch of | Pitch of | |
|---|---|---|---|---|---|---|---|---|---|---|
| | Axial | | | | | Axial | Axial | first | second | NOx |
| | Distance | | | | | Distance | Distance | helical | helical | @ 3% |
| Sample | (A) | L_{B} | TL_{H} | L_{H1} | L_{H2} | (C) | (E) | body | body | O₂/ppm |
| S5 | 156 mm | 905 mm | 857 mm | 155 mm | 155 mm | 100 mm | 547 mm | 812 mm | 381 mm | 34 |

As can be seen in the graph in FIG. 5, sample S5 showed the best reduction of NOx in combination with hot spot activity reduction when compared to CS1.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention.

What is claimed is:

1. A system configured to be installed into a radiant tube for reduction of pollutants, the system comprising:
a body having a tube shape including a length L_{B}, an outer diameter OD_{B}, and an inner diameter ID_{B}, wherein the body further comprises a proximal surface, a terminal surface, and a circumferential surface extending between the proximal surface and terminal surface;
at least two helical bodies each having a substantially helical shape including a length L_{H}, and an outer diameter OD_{H}, wherein an axial distance (E) between the at least two helical bodies is at least 1% of the length L_{H}.

2. The system of claim 1, wherein an axial distance (E) between the first helical body and the second helical body is at least 1% and not greater than 600% of the length (L_{H}) of the at least one helical body.

3. The system of claim 1, wherein the outer diameter of the body, OD_{B}, is at least 0.01 L_{B} and not greater than 1 L_{B}.

4. The system of claim 1, wherein the inner diameter of the body, ID_{B}, is at least 0.01 L_{B} and not greater than 0.5 L_{B}.

5. The system of claim 1, wherein the body is configured to be disposed at an axial distance (A) from a terminal end of a burner.

6. The system of claim 5, wherein the axial distance (A) is at least 0.1% and not greater than 900% of the length (L_{B}) of the body.

7. The system of claim 5, wherein the at least two helical bodies are configured to be disposed at an axial distance (B) from a terminal end of a burner, wherein B>A.

8. The system of claim 7, wherein the axial distance (B) is at least a 0.1% and not greater than 900% of the length (L_{H}) of the at least one helical body.

9. The system of claim 1, wherein a first helical body is disposed at an axial distance (C) from the terminal surface of the body and wherein a second helical body is disposed at an axial distance (D) from the terminal surface of the body, wherein D>C.

10. The system of claim 9, wherein the axial distance (C) is at least 10 mm and not greater than 100 mm.

11. The system of claim 9, wherein the axial distance (D) is at least 10 mm and not greater than 800 mm.

12. A system configured to be installed into a radiant tube for reduction of pollutants, the system comprising:
a body having a tube shape including a length L_{B}, an outer diameter OD_{B}, and an inner diameter ID_{B}, wherein the body further comprises a proximal surface, a terminal surface, and a circumferential surface extending between the proximal surface and terminal surface;
a first helical body closest to the body and a second helical body each having a substantially helical shape including a length L_{H}, an outer diameter OD_{H}, and a pitch, wherein the pitch of the first helical body and the second helical body are different.

13. The system of claim 12, wherein the first helical body comprises a pitch greater than a pitch of the second helical body.

14. The system of claim 12, wherein the pitch of the first helical body is at least 390 mm and not greater than 900 mm.

15. The system of claim 12, wherein the pitch of the second helical body is at least 10 mm and not greater than 900 mm.

16. The system of claim 13, wherein the pitch of the first helical body is at least 1% greater than a pitch of the second helical body.

17. The system of claim 12, wherein the first helical body and the second helical body comprise at least one radial member extending around a central portion of the body.

18. The system of claim 17, wherein the at least one radial member extends for a circumferential distance of at least 1 degree on the central portion of the body, or at least 10 degrees, or at least 30 degrees, or at least 60 degrees, or at least 90 degrees, or at least 180 degrees, or at least 270 degrees, or at least 360 degrees.

19. A system configured to be installed into a radiant tube for reduction of pollutants, the system comprising:
a body having a tube shape including a length L_{B}, an outer diameter OD_{B}, and an inner diameter ID_{B}, wherein the body further comprises a proximal surface, a terminal surface, and a circumferential surface extending between the proximal surface and terminal surface;
a first helical body closest to the body and a second helical body each having a substantially helical shape including a length L_{H}, an outer diameter OD_{H}, wherein the total length of a first helical body, L_{H1}, and the length of the second helical body, L_{H2}, is not greater than 40% L_{B}.

20. The system of claim 19, wherein the total length of a first helical body, L_{H1}, and the length of the second helical body, L_{H2}, is at least 1% and not greater than 39% of the length (L_{B}) of the body.
